(19) United States
(12) Patent Application Publication
(10) Pub. No.: US 2014/0129972 A1
(43) Pub. Date: May 8, 2014

(54) KEYBOARD MODELS USING HAPTIC FEEDABACK AND SOUND MODELING

(71) Applicant: INTERNATIONAL BUSINESS MACHINES CORPORATION, Armonk, NY (US)

(72) Inventors: Matthew J. Jarvis, Sheffield (GB); David Sherwood, Manchester (GB)

(73) Assignee: INTERNATIONAL BUSINESS MACHINES CORPORATION, Armonk, NY (US)

(21) Appl. No.: 14/060,720

(22) Filed: Oct. 23, 2013

(30) Foreign Application Priority Data
Nov. 5, 2012 (GB) 1219838.8

(51) Int. Cl. G06F 3/0488

(52) U.S. Cl. CPC G06F 3/04886
USPC 715/773

(57) ABSTRACT

Provided are techniques for configuring a keyboard model comprising techniques of receiving a keyboard model comprising a plurality of key definitions, each key definition defining at least key function, key location and key size, presenting an output generated from the keyboard model, receiving a user input comprising one or more changes to the keyboard model, updating the keyboard model according to the received user input, and saving the updated keyboard model.

### FIELD OF DISCLOSURE

The claimed subject matter relates a method of, and system for, configuring a keyboard model. In a preferred embodiment, there is provided a system for creating one or more keyboard models on touch screen technology devices using haptic feedback and sound modeling.

### BACKGROUND OF THE INVENTION

Which computer keyboard to use is an intensely personal choice and many people try various different models and makes before finding one that suits their needs. Even then, choices are often a compromise based on the designs that are currently available on the market. The size, shape and feedback of the keys of a keyboard may not be absolutely perfect for each user and this can be compounded for those users with disabilities or for users of certain specialized applications. For many users, their current keyboard is a compromise over the ideal keyboard that they would like to use. It is also the case that keyboards are notoriously easy to break and owing to their low cost are often too cheap to be worth repairing and are simply replaced. These discarded keyboards thus end up forming a large part of the IT waste that is generally buried in landfill, which is environmentally highly undesirable.

### SUMMARY

According to a first aspect of the claimed subject matter, there is provided techniques of configuring a keyboard model, the techniques comprising receiving a keyboard model comprising a plurality of key definitions, each key definition defining at least key function, key location and key size, presenting an output generated from the keyboard model, receiving a user input comprising one or more changes to the keyboard model, updating the keyboard model according to the received user input, and saving the updated keyboard model.

Owing to the disclosed technology, it is possible to provide a keyboard model that can be user configured and can be stored for current and future use. Any device that has the capability to accept the keyboard model can then be configured to provide a keyboard that will suit the specific user, as the user has created the keyboard model to suit their personal choices of key location and size etc. The user can modify the keyboard model at any time if they wish to change the current keyboard configuration. For example, the user can arrange the location of the keys within the keyboard model and can change the size of the keys, so that not all keys need, to be the same size or to use the size that is currently conventional on existing keyboards.

Modern tablet computers and smart phones are often provided with touch screens that can then be configured using the keyboard model that the user has created. The keyboard model can define a large number of different characteristics of the keyboard and of the individual keys and the device that is being configured according to the keyboard model will apply the keyboard model as far as it is able. Any characteristics that are included within the keyboard model that cannot be implemented by the user's device will simply be ignored. For example, the keyboard model may define sound outputs as feedback for specific keys, but if the device that is being configured, according to the keyboard model does not have any audio output means then this part of the keyboard model will be simply ignored.

Advantageously, recent developments in haptic feedback can be harnessed using the keyboard model and it is possible to model a keyboard using a tactile haptic feedback enabled touch screen, using a combination of physical, haptic feedback and sound which would feel to the user like using a real physical keyboard. A combination of physical haptic feedback and sound can be used to model different types of keys onto a touch screen featuring tactile haptic feedback. Users can then easily modify their current keyboard without having to change the physical unit.

In one embodiment, the height, resistance and sound of each key on the keyboard can be modeled, and changing the key would simply be a matter of uploading a new model to the touch screen or changing software preferences manually. In addition, in this embodiment, key size, shape, position and virtual spring point can also be changed, allowing complete customization for each user. For example, a screen could, be placed into an edit mode, and by simply dragging and dropping keys to move, or multi-touch gestures to change key sizes could be utilized. A user can therefore modify their keyboard model at any time and can save the new model or replace the existing keyboard model with the new keyboard model.

Users may also then put together keyboard layouts not using the traditional QWERTY or DVORAK methods, which could be especially useful for people with disabilities, for example by providing oversized keys for the visually impaired, or the tactile haptic feedback could be used to generate Braille or other physically raised identification methods on the key surfaces. Other potential uses would be to produce keyboards for specialized applications where a different number of keys or specialized keys are required. For example, users who often need to produce text in a foreign language such as French could have keys assigned to specific characters such the é or the like, since most keyboards have space beyond the standard characters that is used for function keys and so on. The keyboard model contains key function for each key with the keyboard and the key function does not need to be a letter of the alphabet it could be a commonly used function like “save”.

Using a combination of emerging physical haptic feedback technology and sound models, a software model can be produced of a certain type of keyboard which can then be loaded onto a touch screen with the relevant hardware and software support. The physical and audible feedback can be encoded in the keyboard model and can vary on a key by key basis or can be applicable to all of the keys in the keyboard model. Audible feedback can be incorporated to assist users who have eyesight difficulties, for example. This audible feedback might be the name of key outputted to a user after they have pressed a key.

This summary is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed description.

### BRIEF DESCRIPTION OF THE DRAWINGS

A better understanding of the claimed subject matter can be obtained when the following detailed description of the disclosed embodiments is considered in conjunction with the following figures.

FIG. 1 is a schematic diagram of a tablet computer.

FIG. 2 is a schematic diagram of a desktop computer.

FIG. 3 is a flowchart of a method of configuring a keyboard model.

FIG. 4 is a schematic diagram of a keyboard model and the corresponding keyboard, before and after user changes.

FIG. 5 is a side view of a key of a keyboard.

FIG. 6 is a further schematic diagram, similar to FIG. 2, of a desktop computer.

### DETAILED DESCRIPTION

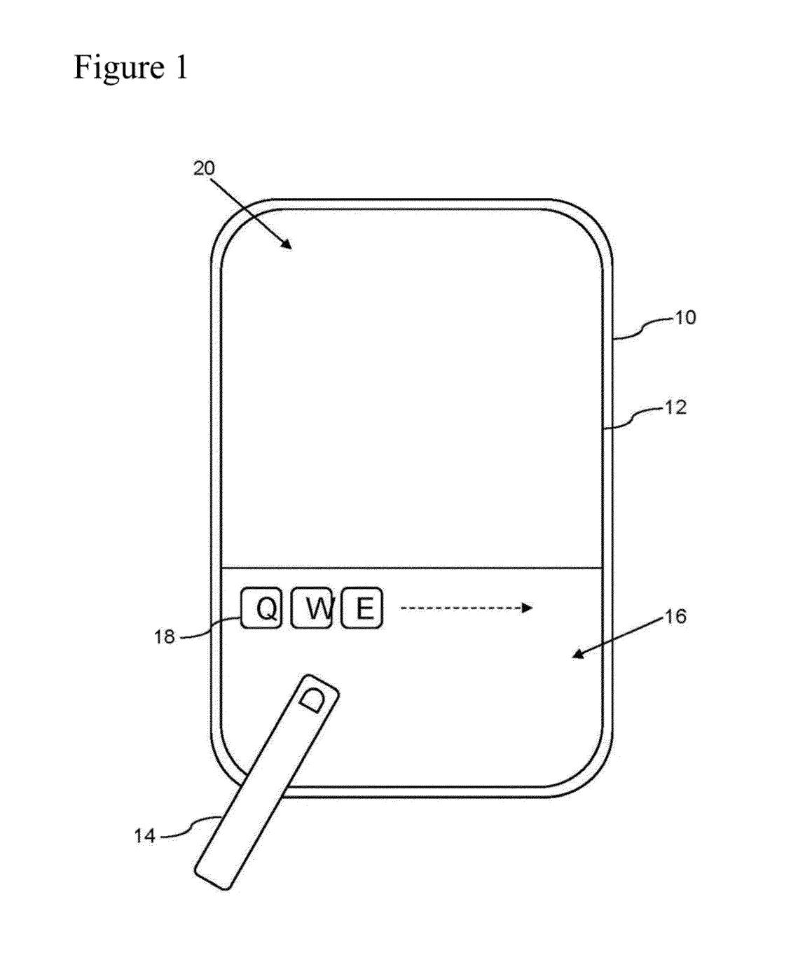

FIG. 1 is a schematic diagram of a tablet computer 10. The tablet computer 10 has a touch screen 12 which acts as a user interface. The touch screen 12 provides display functionality and also allows a user to provide input using, for example, a finger 14 to touch the screen 12. Different touch screen technologies are available, all based around sensing the presence of the user's finger 14 in the relevant screen location. Some touch screens 12 will provide the sensation of pressure when the user's finger 14 touches and presses the screen 12 whereas other touch screen technologies will simply provide a flat and smooth surface that does not depress when the user's finger touches the screen.

The tablet computer 10 is displaying a keyboard 16, which is a conventional “QWERTY” keyboard, which is a very well-known keyboard layout to European, US and other English speaking users of keyboards, and originates in the design of typewriters from the 19^{th} century. The vast majority of desktop computers are sold with a hardware “QWERTY” keyboard, in this keyboard configuration, the keys 18 are laid out in three rows, with the alphabet keys all the same size and shape and the letters arranged generally according to the frequency of use matching the preferred fingers of a user's hands. Other keyboard layouts are known and used for hardware keyboards that are theoretically improvements on the “QWERTY” keyboard.

The popularity of tablet computers has led to them being widely used in personal and business computing. The keyboard 16 allows the user to compose text on their tablet computer 10, as is conventional on desktop and laptop computers. The user will move their finger 14 to each key 18 of the keyboard 16 in turn and touch the screen 12, to compose their text, for an email message for example. The upper part 20 of the touch screen 12 displays the characters that the user is generating via their presses on the keys 18 of the keyboard 16. To indicate the specific key 18 that has been pressed, the image of that key 18 will be momentarily enlarged.

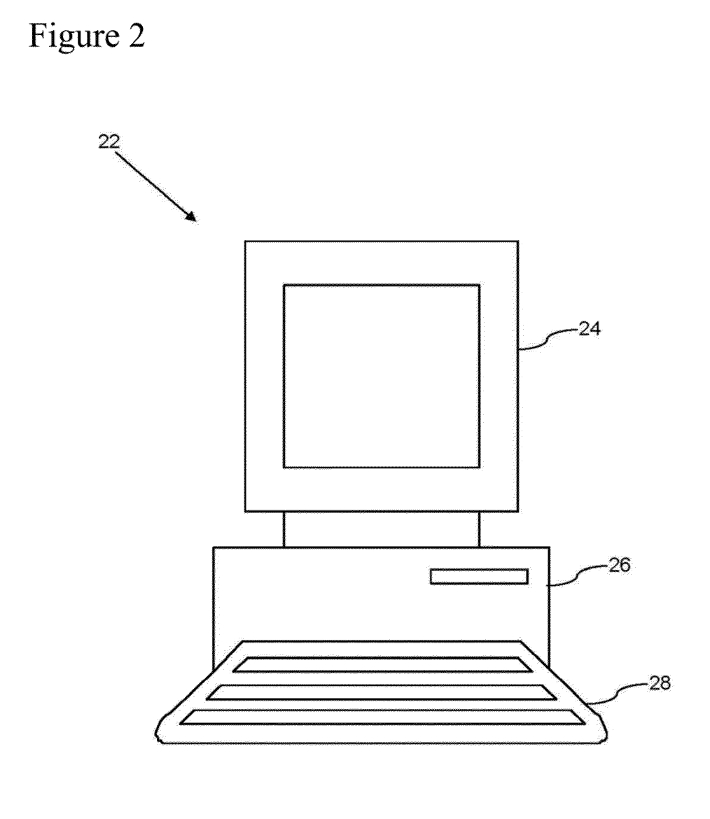

FIG. 2 shows a desktop computer 22, which comprises a display device 24, a processing device 26 and a keyboard 28. The keyboard 28 is itself a touch screen device that displays the arrangement of the keys of the keyboard 28 and receives user input by the user pressing the keys as if it were a conventional, hardware keyboard. The keyboard 28 is a haptic feedback device, which means that it has the capability to provide the user with physical feedback when the user interacts with the keyboard 28. When the user presses a key on the haptic feedback keyboard 28, they will experience a push down and rebound sensation similar to that of a conventional hardware keyboard.

Although the keyboard 28 will default to the conventional “QWERTY” keyboard when in use, the desktop computer 22 is arranged so that a user can configure the keyboard 28 to any arrangement that they wish to use and this arrangement can be saved and reused on other devices, such as the tablet computer 10 of FIG. 1. Key functions, key locations and key sizes can all be changed by the user to suit their own particular needs. For example, if the user has difficulties with their eyesight, then they may wish to dispense with many of the least used non-alphabet keys and increase the size of the conventional alphabet keys.

The arrangement of the keys on the keyboard 28 is stored in a keyboard model that comprises a plurality of key definitions, each key definition defining at least key function, key location and key size. Key feedback and key shape can also be included in the keyboard model The user is able to configure a keyboard model as they desire the keyboard to look and feel. For example, the force feedback received from the haptic feedback keyboard 28 may be too great and the user can lower this feedback level, which will be stored in the keyboard model. If the keyboard model is applied to a device that cannot adjust the force feedback, such as the tablet computer 10 of FIG. 1, then this aspect of the model will be ignored.

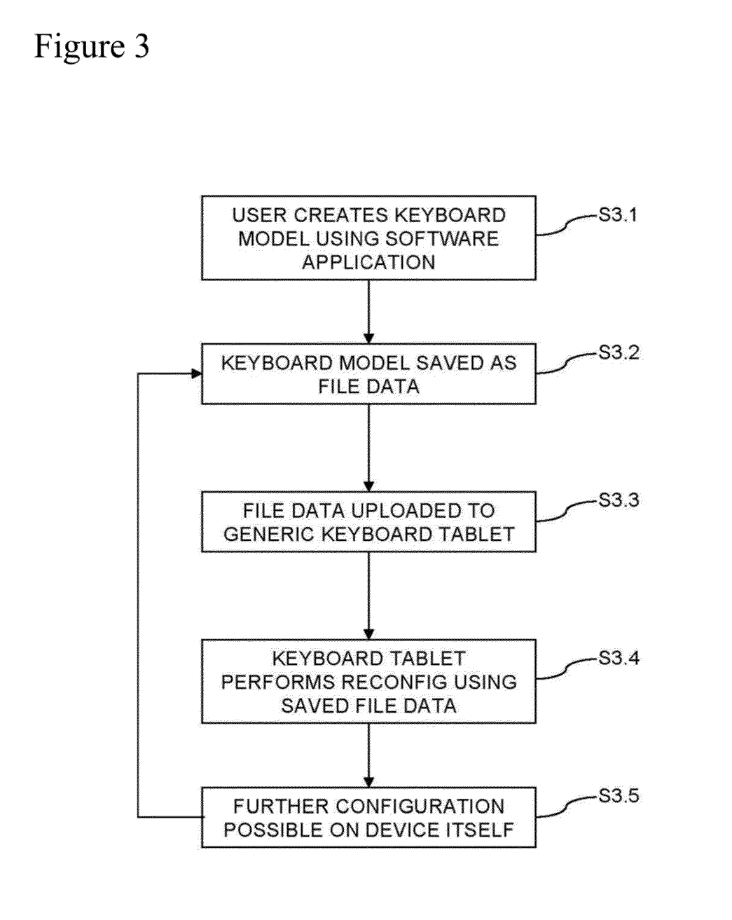

FIG. 3 shows a flowchart of a method of configuring the keyboard model. At step S3.1, the user creates the keyboard model using a suitable software application. The processor 26 of the desktop computer 22 can run an application that will present the user with one or more existing keyboard models that the user can then change to create their own personal keyboard model. The user can move keys around the keyboard, add or delete keys, change sizes and shapes and specify the feedback from the keys and so on. Once the user has completed this process, then at step S3.2, the keyboard model is saved as a file, for example as an XML or text file.

At step S3.3, the file is uploaded to a generic keyboard tablet, such as the tablet computer 10 of FIG. 1. or the haptic feedback keyboard 28 of FIG. 2. At step S3.4, the keyboard tablet performs reconfiguration using the saved file data. The keyboard model is used to configure the keyboard that the user has available to them and will provide the user with a configured keyboard that has their preferred key locations, size and shapes etc. If the keyboard model is sufficiently detailed to include elements that the current keyboard cannot provide, such as specific feedback, then these elements are ignored and the current keyboard will implement the keyboard model as far as possible.

At step S3.5, further configuration of the keyboard model is possible on the current device itself. The user may refine the keyboard model at any time, even when they are actually using a keyboard that has been configured according to their personal keyboard model. This interaction can be directly with the keyboard configuring the keyboard model (as in the FIG. 1 example) or may be via an on-screen display (as in the FIG. 2 example). Any of the components of the current keyboard model can be adjusted and the method will cycle back to step S3.2, saving the updated keyboard model as a new file and reconfiguring the current keyboard to reflect the changes.

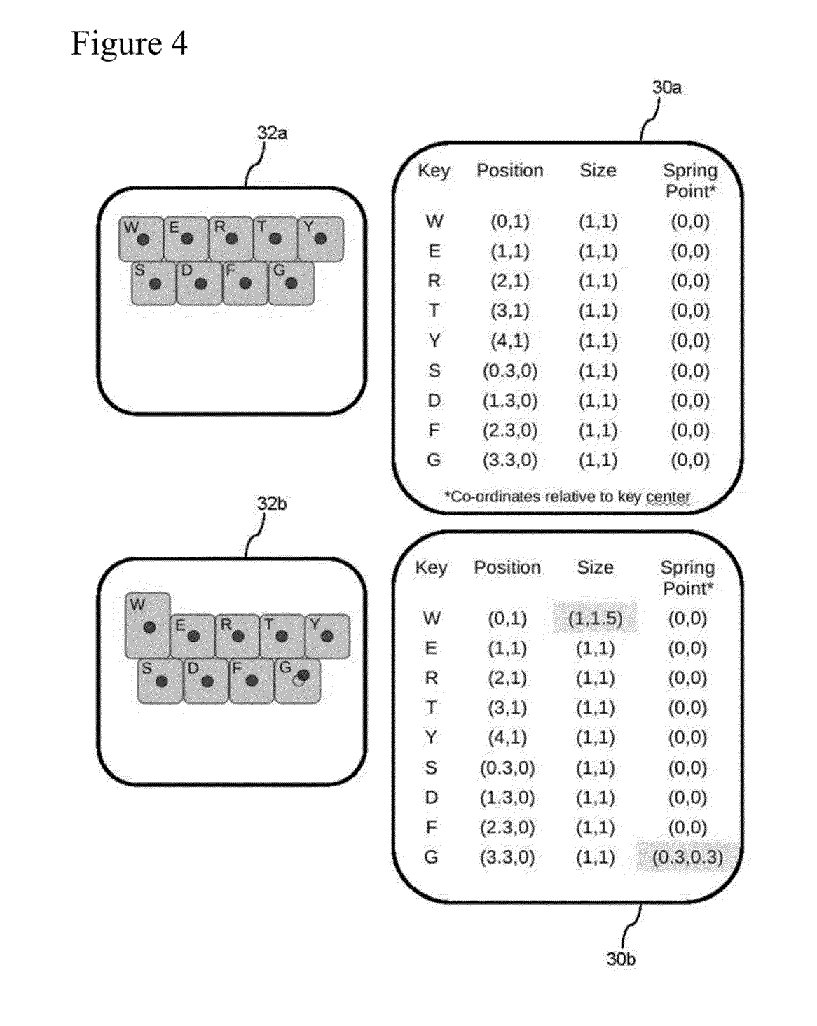

An example of part of a keyboard model 30 and a corresponding output 32 generated from the keyboard model 30 are shown in FIG. 4, with the upper image representing the keyboard model 30a and the corresponding output 32a prior to amendment by the user and the lower image representing the keyboard model 30b and the corresponding output 32b after amendment by the user. Only nine keys 18 of the keyboard are shown in output 32 in order to simplify the illustration of the principle of the keyboard model 30. The keyboard model 30 shows a table comprising nine rows, each row corresponding to a key 18 in the keyboard.

The keys 18 in question are in two rows, with a top row of WERTY and a lower row of SDFG as in a standard “QWERTY” keyboard layout. Each row within the keyboard model 30 defines key function, key location, key size and. key spring point. The key location/position can be recorded in absolute x, y terms or can be expressed as a relative measurement relative to the previous key, for example. The key size is expressed as x, y side lengths, assuming that every key is rectangular, although there is no reason that more complicated key shapes cannot be accommodated. The spring point is expressed as co-ordinates relative to the key center.

The user has made two changes to the keyboard layout and these changes are shown in both the model 30b and in the corresponding output 32b. The keys “W” and “G” have been changed by the user. In the case of the “W” key, the user has increased the y dimension by 50% to make this key larger and easier to locate and press. This change is reflected in the size now showing as (1, 1.5) for the V key, which is the first row in the table of the keyboard model 30. In the case of the “G” key, the user has moved, the spring point away from the centre of the key and the final row in the table of the keyboard model 30 has the spring point at (0.3,0.3).

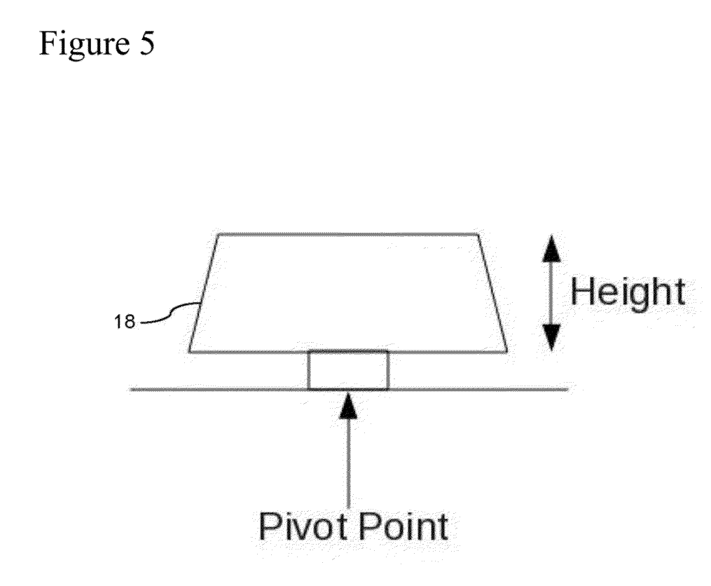

FIG. 5 shows a side view of a single key 18 as it would look in a traditional hardware keyboard. The key 18 has a physical height and also a pivot point about which the key 18 will pivot when it is pressed. A haptic feedback keyboard 28 (as shown in FIG. 2) is able to generate a height in the keys that are being created by the keyboard and is also able to provide a feedback sensation that is equivalent to the pivot point of a conventional key 18. As the user presses a key 18 on the haptic feedback keyboard 28 the press they will make will feel like a conventional key 18 rotating around a pivot point.

The height and pivot point of each key can be contained within the keyboard model that the user is configuring for their ideal keyboard. The user can adjust these values in just the same way as they can adjust the position and size of the keys 18. If the user is actually working with a haptic feedback keyboard 28 they can experiment with different types and positions of pivot points to see how this would change the actual keyboard they are using and find the values that suit them the best. The height of the individual keys on the haptic feedback keyboard 28 can also be adjusted in the same way.

Feedback from the keys 18 of the keyboard can also be contained within the keyboard model. While this can relate to the physical feedback, such as the location of the spring point and the amount of return pressure provided by the haptic feedback keyboard 28, other aspects of the feedback could also be included within the keyboard model. For example, specific sounds could be attached to specific keys or indeed the actual function of the key could be outputted each time it is pressed, in order to assist users who have eyesight difficulties. This would mean that when the key “W” is pressed, a confirmatory sound of the letter “W” is also outputted.

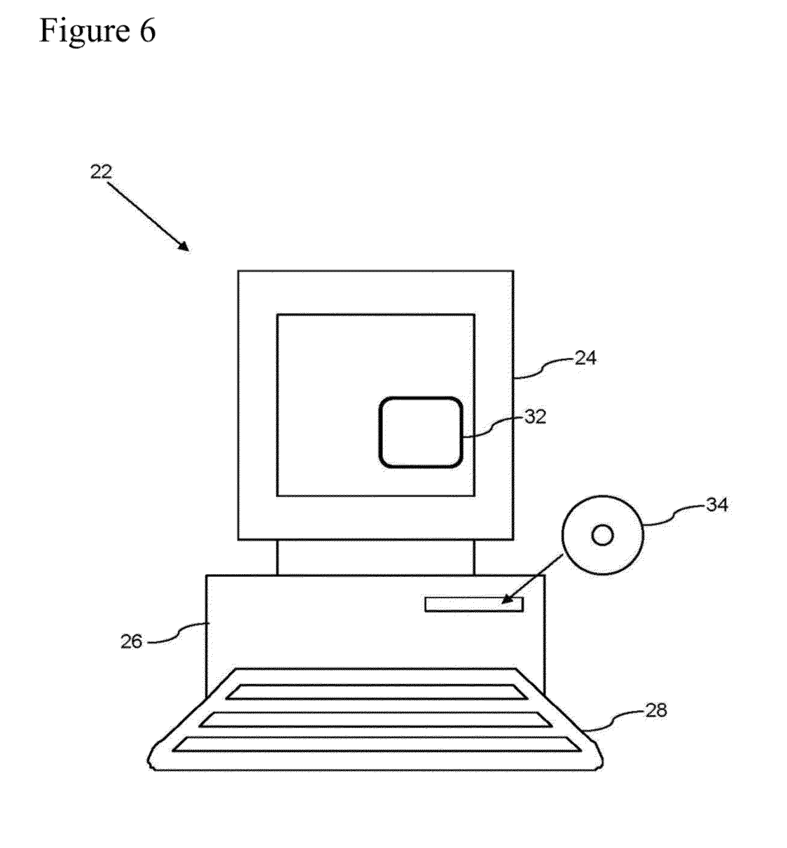

FIG. 6 shows a view similar to FIG. 2 of a desktop computer 22, which a user is using with a haptic feedback keyboard 28. The keyboard 28 is configured according to a keyboard model that the user has previously created and adjusted to their own personal tastes. If the user wishes to further amend the keyboard model, for example to customize the keyboard model to a particular workload that they are working through, then the processor 26 will run a specific software application to amend the keyboard model. A computer program product on a computer readable medium 34 (a CD-ROM) comprises instructions that are executed by the processor 26.

In response to the user opening the application that allows them to amend the current keyboard model, the user is presented with an output 32 that is generated from the keyboard model. The processor 26, via the keyboard 28, receives user input comprising one or more changes to the keyboard model, updates the keyboard model according to the received user input, and then saves the updated keyboard model The new keyboard model could overwrite the previous keyboard model or could be saved as a new version that is available as an alternative to the original existing keyboard model. A user can create as many different keyboard models as they wish and load and use different keyboard models at different times.

It is also possible for users to make their keyboard models available to other users. For example, In a business environment, a user may have designed a keyboard model that is specific to a particular type of work such as a specific language in translation or software development work. The user can save this keyboard model with a suitable filename and. store the keyboard model in a predetermined place such as a keyboard model directory. This will allow other users to find the keyboard model and use it themselves in their work. Other users can download these keyboard models and amend them further themselves, if they wish to improve or customize the keyboard models.

As will be appreciated by one skilled in the art, aspects of the claimed subject matter may be embodied as a system, method or computer program product. Accordingly, aspects of the claimed subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the claimed subject matter may take the form of a computer program, product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RP, etc., or any suitable combination of the foregoing.

Computer program code for carrying out operations for aspects of the claimed subject matter may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network. (LAN) or a wide area network (WAN), or the connection may be made to an external computer (tor example, through the Internet, using an internet Service Provider).

Aspects of the claimed subject matter are described herein with reference to flowchart illustrations and/or block diagrams of methods, apparatus (systems) and computer program products according to embodiments of the claimed subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium, produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the claimed subject matter. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved, it will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

We claim;

1. A method, comprising;
receiving a keyboard model comprising a plurality of key definitions, each key definition defining at least key function, key location and key size;
presenting an output generated from the keyboard model;
receiving a user input comprising one or more changes to the keyboard model;
updating the keyboard model according to the received user input; and
saving the updated keyboard model.

2. The method of claim 1, wherein each key definition further defines key feedback.

3. The method of claim 1, wherein each key definition further defines key shape.

4. The method of claim 3, wherein the key shape of each key definition includes the height of the respective key.

5. The method of claim 1, further comprising applying the updated keyboard model to a touch screen device.

6. An apparatus, comprising:
a processor;
a non-transitory memory coupled to the processor; and
instructions, stored on the memory and executed on the processor, for:
receive a keyboard, model comprising a plurality of key definitions, each key definition defining at least key function, key location and key size:
present an output generated from, the keyboard model; receive a user input comprising one or more changes to the keyboard model;
update the keyboard model according to the received user input; and
save the updated keyboard model.

7. The apparatus of claim 6, wherein each key definition further defines key feedback.

8. The apparatus of 6, wherein each key definition further defines key shape.

9. The apparatus of claim 8, wherein the key shape of each key definition includes the height of the respective key.

10. The apparatus of 6, wherein the processor is further arranged to apply the updated keyboard model to a touch screen device.

11. A computer program product, comprising:
a non-transitory computer readable medium; and
instructions, stored on the computer readable medium for execution on a processor, for:
receiving a keyboard model comprising a plurality of key definitions, each key definition defining at least key function, key location and key size;
presenting an output generated from the keyboard model;
receiving a user input comprising one or more changes to the keyboard model;
updating the keyboard model according to the received user input; and
saving the updated keyboard model.

12. The computer program product, of claim 11, wherein each key definition further defines key feedback.

13. The computer program product of claim 11, wherein each key definition further defines key shape.

14. The computer program product of claim 13, wherein the key shape of each key definition includes the height of the respective key.

15. The computer program product of claim 11, the instructions further comprising instructions for applying the updated keyboard model to a touch screen device.
